(19) United States
(12) Patent Application Publication
(10) Pub. No.: US 2002/0100350 A1
(43) Pub. Date: Aug. 1, 2002

(54) Sliding fence for a compound miter saw

(76) Inventor: Kenneth M. Brazell, Piedmont, SC (US)

Correspondence Address: John E. Nemazi, Brooks & Kushman P.C., 1000 Town Center, 22nd Floor, Southfield, MI, 48075-1351, US

(21) Appl. No.: 10/043,410

(22) Filed: Jan. 10, 2002

Related U.S. Application Data
(60) Provisional application No. 60/262,133, filed on Jan. 16, 2001.

(51) Int. Cl. B26D 7/06; B26D 1/14

(52) U.S. Cl. 83/438; 83/522.11; 83/471.3

(57) ABSTRACT

A fence assembly is provided for a compound miter saw having a saw blade which is tiltable relative to a planer work surface. A first fence portion is affixable to the saw on one side of the saw blade. A second fence portion is affixable to the saw on the opposite side of the saw blade toward which the blade is tiltably adjusted. The second fence portion is made up of a fixed section mounted to the table surface and an adjustable section mounted to the fixed portion and transversely adjustable toward and away from the saw blade, enabling the workpiece to be supported adjacent the saw blade when the saw blade is in the vertical orientation, yet allowing the adjustable fence portion to move outward to provide sufficient clearance for the saw blade at the maximum tilt orientation. A scale is provided on the fixed and adjustable sections of the second fence portion providing an indication of maximum inboard position for various tilt angles.

### CROSS-REFERENCE TO RELATED APPLICATIONS

This application claims the benefit of U.S. provisional application Serial No. 60/262,133 filed Jan. 16, 2001.

### BACKGROUND OF THE INVENTION

1. Field of the Invention

The present invention relates to fences for miter saws and in particular, to compound miter saws.

2. Background Art

Compound miter saws both of the fixed pivot arm type and the sliding type are generally provided with a rotary table, right and left fixed table portions which collectively define a horizontal planer table surface and a stationary fence which extends perpendicularly upward from the rear edge of the table surface. A workpiece to be cut is supported and/or clamped against the horizontal table and the fence to stabilize the workpiece during the cutting process. Miter saw fences are typically provided with an open center section aligned at a rotary saw blade and right and left vertical support surface on opposite sides of the saw blade. In order to maintain the right and left fence portions in a common plane, fences are frequently made of unitary casting with the right and left fence portions interconnected by a low profile C-shaped section located sufficiently behind the back of the saw blade so as to avoid interference.

If the user wants to vary the miter angle, the rotary table and the saw blade are pivoted about a generally vertical axis. In order to make a compound miter cut, the saw blade and a motor arm assembly is tilted about a horizontal axis which lies proximate the plane of the rotary table. Typically, the saw blade will be able to be adjusted from a vertical position to a 45° counter-clockwise position when viewed from the front of the miter saw. In order to accommodate blade movement, the left fence portion needs to be cut away sufficiently so as to not interfere with the saw blade or the associated protective guard housing when the saw is being used at the maximum tilt angle. Unfortunately, when the saw is used with the saw blade perpendicular to the rotary table, i.e. “0” tilt, the cutaway left fence provides less support than desirable, particularly when cutting short length tall height workpiece. To address this problem in the past, some users have installed temporary fence extensions, such as ½″ thick hardwood boards overlying the right and left fence members. These fence extensions can be taller and extend inwardly toward the saw blade as far as possible without interfering with the blade or guard moving at the “0” tilt orientation. When the saw blade needs to be tilt, the fence extension must be removed in order for the saw blade and motor arm assembly to tilt.

In an attempt to maximize the fence area and workpiece support, efforts have been made to create fences which are shiftable by the user. Shiftable fences must be set using a trial and error technique, typically by moving the fence inboard while holding the blade in the plunged position in order to maximize support while protecting interference. Simply setting the fence by eye can result in interference between the blade guard and the fence during a cut, which invariably will result in a less than perfect cut in the workpiece since the workpiece will have to be unclamped and the fence readjusted, the workpiece reclamped and the cutting process continued.

### SUMMARY OF THE INVENTION

The present invention is intended to provide a slidable fence to enable the position of the fence to be varied inwardly in order to maximize the support at various tilt angles of the blade assembly. Accordingly, a compound miter saw is provided with a fence assembly having a right and left fence portion extending on opposite sides of the tiltable blade assembly. At least one of the fence assemblies is provided with an adjustable section which may be moved transversely toward and away from the saw blade. The adjusted section is fixable to a fixed section of the fence assembly mounted to the table at various positions which provides clearance between the saw blade and the fence assembly, in order to maximize the support of the workpiece in the region immediate the saw blade. A scale is provided on the fixed and adjustable fence sections providing an indication of maximum inboard position for various tilt angles.

### BRIEF DESCRIPTION OF THE DRAWINGS

FIG. 1 is a front perspective view of a miter saw incorporating a fence of the present invention at a “0” blade tilt orientation;

FIG. 2 is a view of the miter saw of FIG. 1 with the blade tilted at 45°;

FIG. 3 is a front perspective view of an alternative miter saw embodiment;

FIG. 4 is a left quarter perspective view of the miter saw of FIG. 3;

FIG. 5 is a front view of a sliding fence assembly utilized on the miter saw of FIG. 3 with the fence position at the “0” tilt orientation;

FIG. 6 is an enlarged partial view of the sliding fence of FIG. 5 with the fence position at the 15° tilt orientation;

FIG. 7 is an enlarged partial front view of the sliding fence of FIG. 5 with the fence position at the 30° tilt orientation;

FIG. 8 is a rear view of the sliding fence of FIG. 5;

FIG. 9 is an exploded perspective view of the rear side of the sliding fence; and

FIG. 10 is a front view illustrating an alternative scale embodiment, but otherwise corresponding to the adjustable fence section shown in FIG. 7.

### DETAILED DESCRIPTION OF THE PREFERRED EMBODIMENT(S)

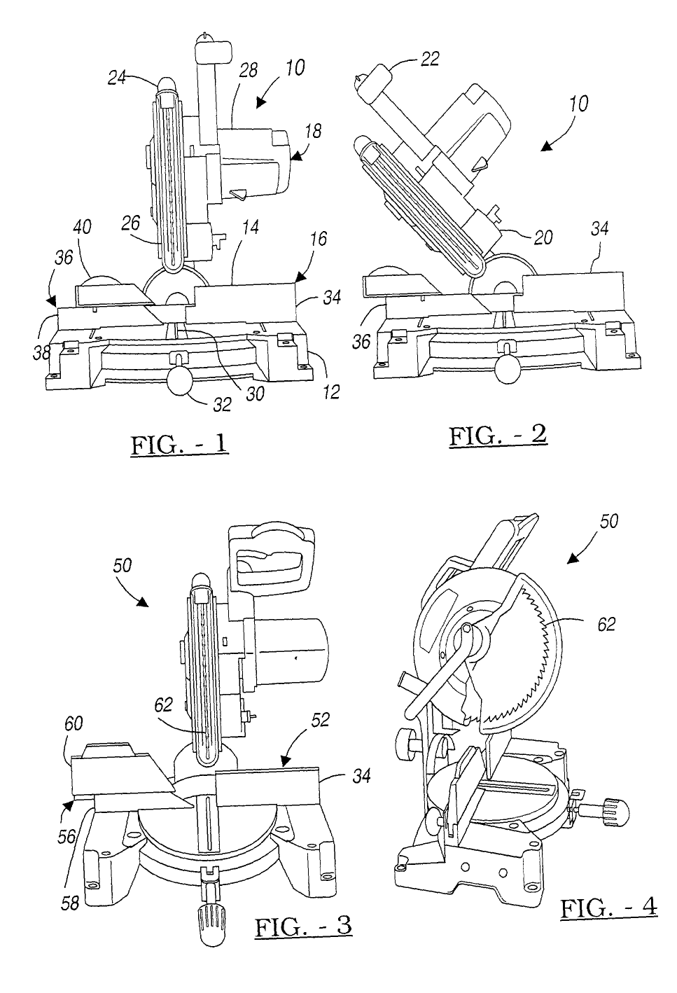

FIGS. 1 and 2 illustrate a first compound miter saw 10 incorporating the present invention. Compound miter saw 10 is provided with a fixed base 12, a rotary table 14 which is pivotable relative to the fixed base 12 about a vertical axis. Fixed base 12 and rotary table 14 collectively define a horizontal planer support surface as illustrated. Attached to fixed base 12 and spanning across rotary table 14 is fence assembly 16 which provides a vertical planer support surface which is perpendicular to the horizontal table surface of fixed base 12 and rotary table 14. The horizontal table surface and the perpendicular support surface of the fence collectively support workpieces while they are being cut on the compound miter saw. The compound miter saw further includes a pivoting arm rotary saw assembly 18 which operates in a conventional fashion. The arm assembly is provided with a fixed end 20 pivotally connected to rotary table 14 and a distal end terminating in a handle 22. Intermediate the fixed and distal ends of the rotary saw assembly 18 is a rotary saw blade 24, which is protected by a suitable guard 26 and driven by a conventional motor assembly 28.

In use, to make a conventional square cut in a workpiece, the saw as oriented in the position shown in FIG. 1, is capable of being downwardly pivoting about the fixed end 20 causing the saw blade 24 to pass through the workpiece supported on the horizontal table surface and to continue through a slot 30 until the workpiece is completely severed in two. In order to form a miter cut, a table lock 32 is released enabling the entire saw blade 24 and the rotary saw assembly 18 to rotate relative to the fence assembly 16. Alternatively, one can make a simple miter cut by tilting the saw blade as illustrated by the miter saw in the position shown in FIG. 2 where the arm assembly and saw blades are rotated and locked at a selected angle about a generally horizontal axis aligned parallel to the rotary table 14 and the slot 30 formed therein. When making a compound miter cut, the rotary table 14 is oriented so that the slot 30 extends at an angle relative to the fence assembly 16 in addition to having the saw blade tilted relative to the table surface as shown in FIG. 2.

When the saw blade is tilted counter-clockwise to the left viewed from the front as shown in FIG. 2, the fence portion to the left of the saw blade 24 must be appropriately cut away to provide clearance for the saw blade and a surrounding guard 26. Conventional fence assemblies are cut away in order to provide clearance for the saw blade and surrounding guard at the maximum tilt angle throughout the entire range of table rotation. Accordingly, the left fence is frequently undersized and provides less support than desirable when cutting short length tall height workpieces. To solve this problem, the present fence assembly 16 is made up of a first fixed fence portion 34 on the right hand side of the table surface and a second fence portion 36 on the left side of the table surface. The second fence portion includes a fixed section 38 mounted on the horizontal table surface of the base 12 and an adjustable section 40 which slidably mounts on the fixed section 38 for transverse movement toward and away from the saw blade 24. In the illustration of FIG. 1, the adjustable section 40 is moved toward the saw blade 24 and locked in a position which provides maximum support for a short length tall height workpiece. When it is desired to tilt the saw blade to a 45° angle as shown in FIG. 2, the adjustable section 40 is shifted away from the saw blade and locked in position to provide adequate clearance for the saw blade 24 and the surrounding guard assembly 26.

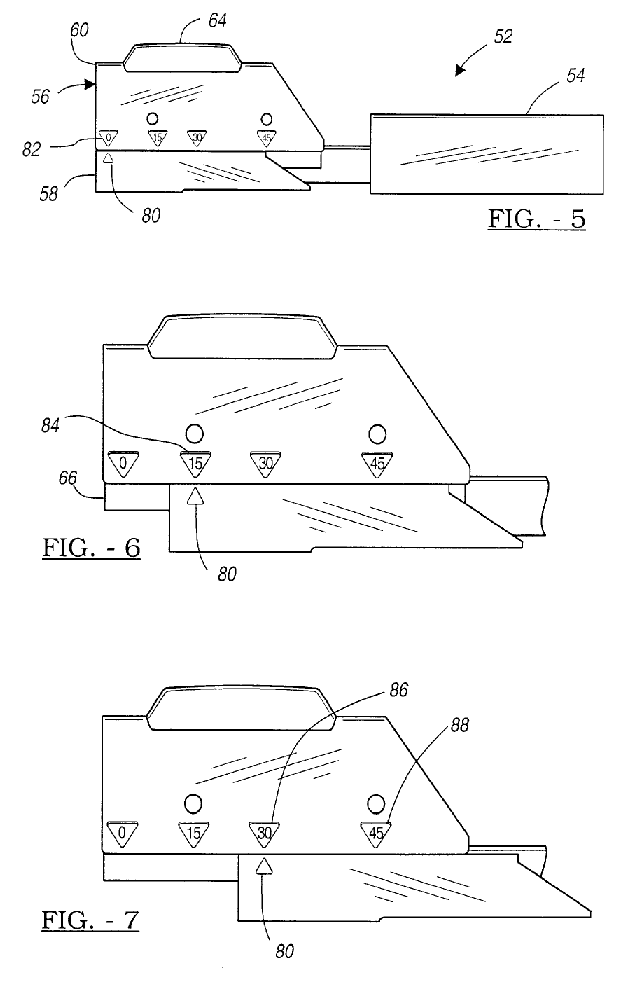

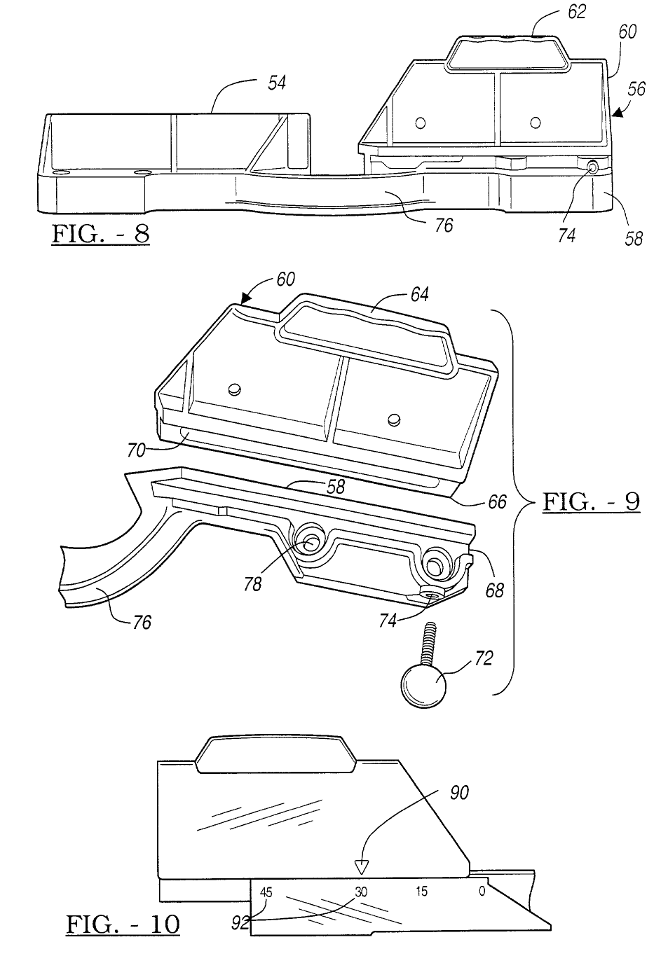

An alternative embodiment of the miter saw of the present invention is illustrated in FIGS. 3 and 4 with details of the adjustable fence assembly further illustrated in FIGS. 5-9. Compound miter saw 50 illustrated in FIGS. 3 and 4, functions in a similar manner to miter saw 10 described with reference to FIGS. 1 and 2, the differences being primarily routine design choices. Compound miter saw 50 is similarly provided with an adjustable fence assembly 52 comprising a first fence portion 54 and a second fence portion 56 made up of a fixed section 58 and an adjustable section 60. The fixed and adjustable sections 58 and 60 of the second fence portion 54 collectively define a planer vertical fence surface, to the left of a rotary saw blade 62, which is generally co-planer with a corresponding planer support surface associated with first fence portion 54 to the right of the saw blade 62.

An enlarged front view of the fence assembly removed from the miter saw is shown in FIG. 5. The adjustable section 60 is preferably provided with a high handle region 64 at the upper edge of the adjustable section 60 to be grasped by the user. The adjustable section 60 is slidably movable relative to the fixed section 58. In the embodiment illustrated, this sliding connection is achieved by a tongue and groove connection. A tongue 66 is provided on the adjustable section 60 and a groove 68 (best seen in FIG. 9) is provided in the fixed section 58. Ideally, the rear side of the tongue 66 will be provided with a groove 70 into which the end of the bolt portion of a locking knob 72 will extend. The locking knob 72 is provided with a threaded bolt section which threadily cooperates with bore 74 in the fixed section 58 of the second fence portion 56 as illustrated in FIG. 9.

The user can conveniently grasp the knob portion of the locking knob 72 to loosen and re-tighten the locking knob 72 to facilitate adjustment and re-locking of the adjustable section 60 relative to the fixed section 58 of the second fence portion 56. Of course, other sliding joints and other forms of locking mechanisms can be alternatively used such as through slots extending through one of the fixed or adjustable fence portions and a corresponding bolt or other forms of linear guide ways. Additionally, while only one locking knob 72 is illustrated, multiple locking knobs or additional screws or structure can be added to interconnect the fixed and adjustable sections of the second fence portion.

In order to maintain the second fence portion face square to the table, the adjustable and fixed sections of the second fence forming the planar fence face are machined surfaces. Ideally, at least a portion of the sliding contact between the fixed and adjustable fence will similarly be machined in order to maintain the fixed and adjustable fences in coplanar alignment. Preferably, as is conventionally known, the first fence portion 54 and the second fence portion 56 are maintained in proper alignment by integrally forming the fence portions from a common casting as illustrated in FIG. 8. The first fence portion 54 and the fixed section 58 of the second fence portion 56 are interconnected by a generally C-shaped bight section 76. The bight section 76 extends sufficiently rearward of the blade at maximum ends of cut to provide blade clearance, yet, has sufficient cross-section to provide rigidity to the fence assembly 52. The fence assembly 52 is affixed to the base 12 of the miter saw 50 in a conventional manner using bolts which extend through apertures 78 and the fence assembly 52.

In order to make it easier for the user to position the adjustable section 60 of the second fence portion 56, indicia is provided on the fixed and adjustable sections 58, 60 of the second fence portion 56 as illustrated in FIGS. 5, 6 and 7. In the embodiment of the invention illustrated in FIGS. 3-9, the fixed section 58 of the second fence portion 56 is provided with a pointer 80 cast into the face surface of the fixed section 58 as illustrated. Corresponding pointer markers 82, 84, 86 and 88 are formed in the adjustable section 60. The marker 82 is provided with “0” indicia indicating that the marker 82 should be aligned with the pointer 80 when the saw blade is oriented at the “0” tilt angle. As saw blade tilt increases, the adjustable section 58 of the second fence portion 56 must be moved to the left and accordingly, the additional markers 84, 86 and 88 having 15°, 30°, and 45° indicia are provided to assist the user in locating the adjustable section 60 of the second fence 56 at various blade tilt angles.

Alternatively, as illustrated in FIG. 10, a pointer 90 may be located on the adjustable section 60 of the second fence portion 56 and the corresponding indicia markers 92 may be located on the fixed section 58. The preferred embodiment of the invention illustrated is only a representative example of how the present invention can be implemented in a compound miter saw. Alternatively, the present fence invention could be used on a sliding compound miter saw or it could be adapted to be used on both the right and left fence portions of miter saws which are capable of tilting in both directions.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A fence assembly for a compound miter saw comprising:
a first fence portion affixable to the compound miter saw on a first side of a tiltable saw blade and having a first face extending upwardly and generally perpendicular to a horizontal table surface;
a second fence portion affixable to the compound miter saw on a second side of the saw blade and having a second face extending upwardly and generally perpendicular to the horizontal table surface, wherein the second fence portion is made up of a fixed section mounted to the horizontal table surface and an adjustable section which slidably mounts on the fixed section for traverse movement toward and away from the saw blade; and
a scale having a pointer formed on one of the fixed and adjustable fence sections of the second fence and a series of indicia formed on the other of the fixed and adjustable sections of the second fence providing a visual indication to the user of the proper orientation of the adjustable fence corresponding to the saw blade tilt angle;
wherein when the saw blade is adjustably tilted from vertical toward the second fence portion, the adjustable section of the second fence portion can be moved outward to provide clearance for the saw blade and when the saw blade is returned to the vertical orientation, the adjustable fence section can be moved toward the saw blade to provide additional support for a workpiece to be supported relative thereto while it is being cut by the saw blade.

2. The fence assembly of claim 1 wherein the first fence portion and the fixed section of the second fence portion are integrally formed and interconnected by a bight section.

3. The fence assembly of claim 1 further comprising a locking mechanism for retaining the adjustable section and fixed section of the second fence portion.

4. The fence assembly of claim 1 wherein the fixed and adjustable sections of the second fence portion are interconnected by a tongue and groove joint.

5. The fence assembly of claim 4 wherein the groove is formed on the fixed section and the tongue is formed on the adjustable section of the second fence portion.

6. The fence assembly of claim 5 further comprising a lock member for interconnecting the adjustable and fixed sections of the second fence portion.

7. A miter saw comprising:
a base having a generally planar horizontal table surface;
an arm assembly having a fixed end pivotally connected to the base, a distal end forming a handle and an intermediate section therebetween supporting a rotary saw blade which moves toward and away from the table surface to cut a workpiece positioned thereon as the arm is pivoted about the fixed end, the arm being further tiltably adjusted relative to the base enabling the saw blade to be tilted from perpendicular relative to the table surface to form an angled cut;
a fence assembly affixed to the horizontal table surface of the base defining a planar fence surface supporting the workpiece which extends upwardly perpendicular to the horizontal table surface, the fence assembly having a first fence portion on a first side of the saw blade and a second fence portion on a second side of the saw blade toward which the saw blade moves when it is tilted away from vertical, the second fence portion being made up of a fixed section mounted to the base and an adjustable section which slidably mounts to the fixed section for transverse movement toward and away from the saw blade; and
a scale having a pointer formed on one of the fixed and adjustable fence sections of the second fence portion and a series of indicia on the other of the fixed and adjustable sections of the second fence portion providing a visual indication to the user of the proper orientation of the adjustable fence corresponding to the saw blade tilt angle;
wherein when the saw blade is adjustably tilted away from vertical toward the second fence portion, the adjustable section of the second fence portion can be moved outward to provide clearance for the saw blade and when the saw blade is returned to the vertical orientation, the adjustable section of the second fence can be moved toward the saw blade to provide support for the workpiece to be cut.

8. The miter saw of claim 7 wherein the first fence portion and the fixed section of the second fence portion are integrally formed and interconnected by a bight section.

9. The miter saw of claim 7 further comprising a locking mechanism for retaining the adjustable and fixed sections of the second fence portion.

10. The miter saw of claim 7 wherein the fixed and adjustable sections of the second fence portion are interconnected by a tongue and groove joint.

11. The miter saw of claim 10 wherein the groove is formed on the fixed section and the tongue is formed on the adjustable section of the second fence portion.

12. The miter saw of claim 11 further comprising a lock member for interconnecting the adjustable and fixed sections of the second fence portion.
